(19) United States
(12) Patent Application Publication
(10) Pub. No.: US 2013/0309109 A1
(43) Pub. Date: Nov. 21, 2013

(54) Motor and Fuel Pump

(71) Applicant: Johnson Electric S.A., Murten (CH)

(72) Inventors: Yiu Chung WU, Hong Kong (CN); Chi Hang TO, Hong Kong (CN); Ping Wo POON, Hong Kong (CN)

(73) Assignee: Johnson Electric S.A., Murten (CH)

(21) Appl. No.: 13/895,125

(22) Filed: May 15, 2013

(30) Foreign Application Priority Data
May 16, 2012 (CN) 201210151785.3

(51) Int. Cl. H02K 3/44; F02M 37/08

(52) U.S. Cl. CPC H02K 3/44; F02M 37/08
USPC 417/423.7; 310/85

(57) ABSTRACT

A motor includes a stator and a rotor disposed in the stator. The stator includes a housing and a plurality of magnets attached to an inner surface of the housing. The rotor includes a shaft, with a rotor core and a commutator. Windings are wound on the rotor core and terminated on the commutator. The rotor core includes a plurality of teeth extending outwardly about which the windings are wound. Radially outer surfaces of the teeth are coated with a Zn-Al film.

### CROSS REFERENCE TO RELATED APPLICATIONS

This non-provisional patent application claims priority under 35 U.S.C. §119(a) to Patent Application No. 201210151785.3 filed in The People's Republic of China on May 16, 2012.

### FIELD OF THE INVENTION

This invention generally relates to an electric motor and in particular, to an electric motor with high corrosion resistance used in fuel pump.

### BACKGROUND OF THE INVENTION

Fuel pumps are used in motor vehicles to transfer liquid fuel, typically gasoline or diesel from a fuel tank to an internal combustion engine. The pump includes an impeller driven by a motor. The fuel passes through the interior of the motor when the pump works. Due to the corrosive working environment of the fuel pump, metal surfaces of the motor are required to he coated by a protective coating to prevent corrosion, This is usually done by electroplating a tin film on the metal surfaces. However, the electroplating process is a non environmental friendly process. Moreover, the tin plating film can only withstand up to 46 hours of Salt Spray Test (ASTM b-117), which can not meet the requirement when the motor works in more corrosive fuels.

Therefore, there is a desire for a motor for a fuel pump, with stronger corrosion resistance.

### SUMMARY OF THE INVENTION

Accordingly, in one aspect thereof, the present invention provides a motor including a stator and a rotor disposed in the stator. The stator includes a housing and one or more magnets attached to an inner surface of the housing. The rotor includes a shaft, with a rotor core and a commutator thereon. Windings are wound on the rotor core and terminated at the commutator. The rotor core includes a plurality of teeth extending outwardly. Radially outer surfaces of the teeth are coated with a Zn-Al film.

In another aspect thereof, the present invention provides a motor including a stator and a rotor disposed in the stator. The rotor includes a shaft, with a rotor core fixed thereto. One or more magnets are fixed to the rotor core. The stator includes a housing, a stator core press fit in the housing, and windings wound on the stator core. The stator includes a plurality of inwardly extending teeth. Radially inner surfaces of the teeth are coated with a Zn-Al film.

Preferably, the Zn-Al film consists of a mixture of adhesive, Zn and Al. Ideally the adhesive is a reaction resin.

Preferably, the Zn and Al are in the form of flakes.

Preferably, the Zn-Al film is applied by dip-spin and/or spray technique.

Preferably, the Zn-Al film has a thickness in a range of 5 μm to 30 μm.

Preferably, the Zn-Al film has a thickness in a range of 8 μm to 15 μm.

Preferably, at least one of inner surface and outer surface of the housing of the stator is coated with a Zn-Al coating.

In a third aspect thereof, the present invention provides a fuel pump including an impeller and a motor. The motor includes a rotor and a stator surrounding the rotor. The rotor includes a shaft mechanically coupled to the impeller. A pathway is formed in the motor allowing fuel passing the motor. At least a portion of a metal surface of the motor which directly contacts the fuel is coated with a Zn-Al

Preferably, the rotor further includes a rotor core fixed to the shaft and windings wound on the rotor core. The rotor core includes a plurality of outwardly extending teeth. The stator includes a housing surrounding the rotor core and one or more magnets attached to an inner surface of the housing. The pathway is defined between a radially outer surface of the rotor and an inner surface of the housing.

Preferably, the rotor further includes a rotor core fixed to the shaft and a plurality of magnets fixed to the rotor core. The stator includes a housing, a stator core press fit in the housing and windings wound on the stator core. The stator core including a plurality of inwardly extending teeth. The pathway is defined between an inner surface of the stator and an outer surface of the rotor.

Preferably, at least one recess is formed in a radially outer surface of the stator core, and the recess forms another pathway in the motor, metal surfaces of the stator which directly contact the fuel are coated with a Zn-Al film.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a sectional view of a fuel pump according to a first embodiment of the present invention;

FIG. 2 illustrates a rotor of the motor used in the fuel pump of FIG. 1;

FIG. 3 illustrates a rotor core of the rotor of FIG. 2;

FIG. 4 is a metallographic microscope view of a portion of the rotor core shown in FIG. 3;

FIG. 5 is a sectional view of another fuel pump according to a second embodiment of the present invention; and

FIG. 6 illustrates the motor used in the fuel pump of FIG. 5.

### DETAILED DESCRIPTION OF THE VARIOUS EMBODIMENTS

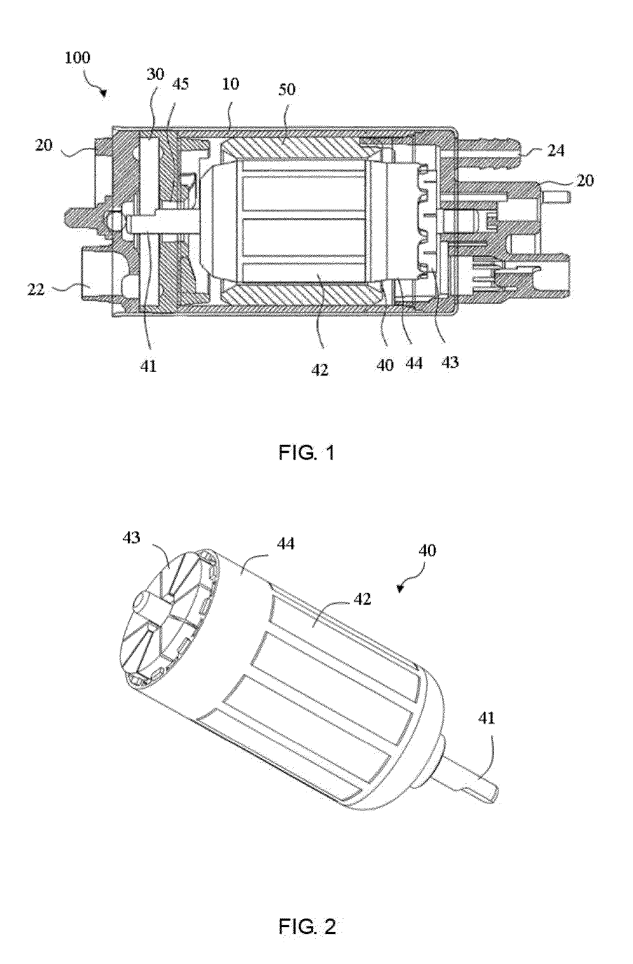

Referring to FIGS. 1 and 2, a fuel pump 100 includes a housing 10, two end caps 20 connected to two open ends of housing 10, an impeller 30 and a motor for driving impeller 30. An inlet 22 is defined in one end cap 20 and an outlet 24 is defined in the other end cap 20 for fuel to flow through the housing. Impeller 30 drives the fuel from inlet 22 to outlet 24.

The motor is a brush motor including a stator and a wound rotor 40. The stator includes a casing and a plurality of magnets 50 attached in an inner surface of the casing. In this embodiment, housing 10 also functions as the casing of the motor and is connected directly to the two end caps. An optional shell covers the housing and at least part of both end caps to further fix the end caps to the housing and improves the sealing between the end caps and the housing. Rotor 40 is received in the stator and is able to rotate relative to the stator. A pathway is defined between the outer periphery of rotor 40 and an inner surface of housing 10 or magnets 50.

Rotor 40 includes a shaft 41, with a rotor core 42 and a commutator 43 thereon. Windings are wound on rotor core 42 and terminated on commutator 43. Shaft 41 of rotor 40 is supported by bearings 45 mounted on end caps 20. Impeller 30 is fixed to an end of shaft 41 so that impeller 30 rotates with the shaft. Due to the rotation, impeller 30 draws fuel into the housing from outside via inlet 22. Fuel flows through the pathway, and then flows out of the housing via outlet 24.

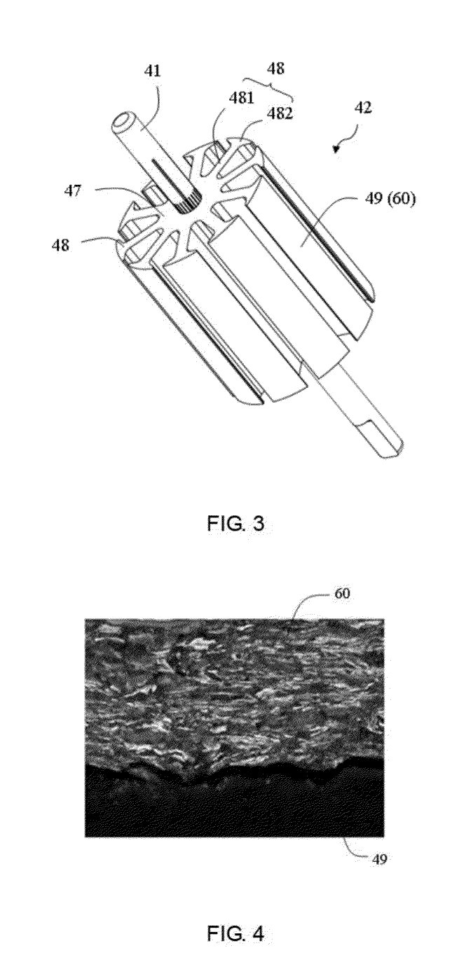

Referring also to FIG. 3, preferably, the rotor core 42 is formed by stacking together a plurality of steel laminations. Rotor core 42 includes a core portion 47, and a plurality of teeth 48 extending outwardly from a periphery of core portion 47. Each tooth 48 includes a neck 481 extending radially from core portion 47, and a head 482 adjoining a radial outer end of neck 481. Head 482 extends circumferentially on either side of the corresponding neck. The radially outer surface of each head 482, confronting the inner surface of the housing 10 or magnets 50, forms a pole surface 49 of the rotor.

Rotor 40 also includes a protecting material 44 that encapsulates the windings and fills in slots between the windings and stator core 42. As such, the windings are protected by protecting material 44 in the aggressive fuel. Preferably, the protecting material 44 is plastic or resin. Pole surfaces 49 of rotor 40 are exposed for good magnetic. coupling or interaction with the stator. Thus, the pole surface is exposed in the pathway and will contact the fuel directly.

Referring also to FIG. 4, a Zn-Al film 60 is coated on pole surfaces 49 of rotor 40, to increase the corrosion resistance of pole surfaces 49 to the fuel, and even to a highly corrosive fuel. Zn-Al film 60 comprises a mixture of adhesive, reaction resins for example, and Zn and Al. Zn and Al are preferred in the form of flakes. Alternatively, Zn and Al can also be particles. Preferably, the Zn-Al film 60 has a thickness in a range of 5 μm to 30 μm, and ideally in a range of 8 μm to 15 μm.

During coating of the Zn-Al film 60, a mixture of the Zn, Al and liquid adhesive is coated on pole surfaces 49 of the rotor using a dip-spin and/or spray technique, and then the mixture is solidified. Therefore, the mixture reacts on the pole surfaces to form an adhesive bonding. Zn-Al film 60 is environment-friendly being free of lead, mercury, cadmium and chromium. As Zn-Al film 60 is applied in a non-electrolytic technique, hydrogen embrittlement is irrelevant.

Rotor core 42 is made of steel, which has a higher potential than either of Zn and Al, and thus Zn-Al film 60 will form a cathodic protection for rotor core 42 in the fuel. More specifically, if corrosion occurs, Al and Zn will be oxidized rather than rotor core 42. A dense alumina film is formed when the Al is oxidized, which provides good protect to pole surfaces 49 of rotor 40. Zinc oxide, formed when Zn is oxidized, covers or fills pores of the alumina film, thereby enhancing the protection for the pole surfaces of the rotor. Zn-Al film 60 is able to withstand more than 480 hours of Salt Spray Test (ASTM B-117), far longer than the tin plating on a traditional motor.

Preferably, inner surfaces and/or outer surfaces of housing 10, which may contact the fuel directly, are applied with the Zn-Al film 60 too. Therefore, corrosion of housing 10 is prevented.

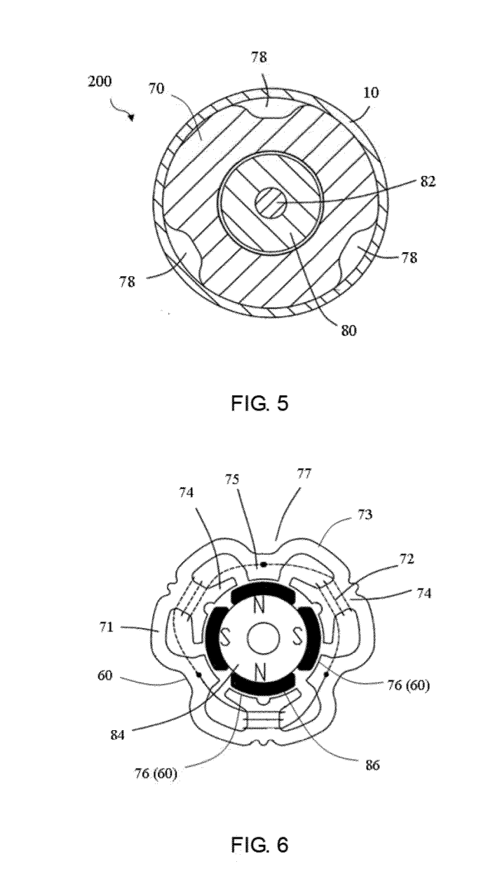

A fuel pump 200 according to a second embodiment is shown in FIGS. 5 and 6. Fuel pump 200 differs from the first one in that, the motor is a brushless motor. Motor includes a wound stator 70 press fit in housing 10 and a rotor 80 rotatably received in stator 70. Rotor 80 includes a shaft 82, a rotor core 84 fixed to shaft 82 and permanent magnets 86 fixed to rotor core 84. An impeller is fixed to shaft 82. Stator 70 includes a stator core 71 and windings 72 wound on stator core 71. Windings 72 are encapsulated in a protection material to prevent corrosion.

Stator core 71 has an annular yoke 73, a number of wound teeth 74 and unwound teeth 75 extend inwardly from yoke 73. The number of the unwound teeth 75 is equal to the number of the wound teeth 74. Wound teeth 74 and unwound teeth 75 are arranged alternately in a circumferential direction of stator core 71.

Stator core 71 has an outer surface that mates with the inner surface of housing 10, with the exception that a plurality of axially extending recesses 77 are formed in the radially outer surface of stator core 71. Recesses 77 form primary fuel pathways 78 between stator core 71. and housing 10 allowing the fuel to flow passed the motor. Radially outer surface of stator core 71, at least portions that defines primary fuel pathway 78 are coated with the Zn-Al film 60 to prevent corrosion. Preferably, inner and outer surfaces of the housing 10 are coated with the Zn-Al film 60.

A small gap between the stator and the rotor form an auxiliary fuel pathway in the motor. Pole surfaces 76 of stator 70, i.e., radially inner surfaces of teeth 74, 75, are also coated with Zn-Al film 60 to increase corrosion resistance.

Although the invention is described with reference to one or more preferred embodiments, it should be appreciated by those skilled in the art that various modifications are possible. Therefore, the scope of the invention is to be determined by reference to the claims that follow.

In the description and claims of the present application, each of the verbs “comprise”, “include”, “contain” and “have”, and variations thereof, are used in an inclusive sense, to specify the presence of the stated item but not to exclude the presence of additional items.

1. An electric motor comprising:
a stator comprising a housing, and a plurality of magnets attached to an inner surface of said housing; and
a rotor disposed in said housing and comprising a shaft, a rotor core fixed to the shaft and including a plurality of teeth extending outwardly, a commutator fixed to the shaft, and windings wound on the rotor core and connected to the commutator,
wherein radially outer surfaces of the teeth are coated, with a Zn-Al film.

2. The motor of claim 1, wherein said Zn-Al film comprises a mixture of adhesive, Zn and Al.

3. The motor of claim 2, wherein said Zn and Al are in the form of flakes.

4. The motor of claim 1, wherein the Zn-Al film is applied by dip-spin and/or spray technique.

5. The motor of claim 1, wherein the Zn-Al film has a thickness in a range of 5 μm to 30 μm.

6. The motor of claim 1, wherein the Zn-Al film has a thickness in a range of 8 μm to 15 μm.

7. The motor of claim 1, wherein at least one of an inner surface and an outer surface of the housing of the stator is coated with a Zn-Al coating.

8. A motor, comprising:
a stator comprising a housing, a stator core press fit in the housing, the stator core comprising a plurality of inwardly extending teeth, and windings wound on the stator core; and
a rotor disposed in said stator and comprising a shaft, a rotor core fixed to the shaft, and a plurality of magnets fixed to the rotor core,
wherein a radially inner surface of the teeth are coated with a Zn-Al film.

9. The motor of claim 8, wherein the Zn-Al film comprises a mixture of reaction resin, Zn and Al.

10. The motor of claim 9, wherein said Zn and Al are in the form of flakes.

11. The motor of claim 8, wherein the Zn-Al film has a thickness in a range of 5 μm to 30 μm.

12. The motor of claim 8, wherein, the Zn-Al film has a thickness in a range of 8 μm to 15 μm .

13. A fuel pump, comprising an impeller and a motor, said motor comprising:
a rotor comprising a shaft mechanically coupled to said impeller; and
a stator surrounding said rotor;
wherein a pathway is formed in said motor allowing fuel to pass through the motor, and at least a portion of a metal surface of said motor which directly contacts said fuel is coated with a Zn-Al film.

14. The fuel pump of claim 13, wherein said rotor further comprises:
a rotor core fixed to said shaft and including a plurality of outwardly extending teeth; and
windings wound on the plurality of teeth; and
said stator comprises:
a housing surrounding said rotor core; and
a plurality of magnets attached to an inner surface of said housing;
wherein said pathway is defined between a radially outer surface of said rotor and an inner surface of said housing.

15. The fuel pump of claim 13, wherein said rotor further comprises:
a rotor core fixed to said shaft; and
a plurality of magnets fixed to said rotor core; and
said stator comprises:
a housing;
a stator core press fit in said housing, the stator core including a plurality of inwardly extending teeth; and
windings wound on said stator core;
wherein said pathway is defined between an inner surface of said stator and an outer surface of said rotor.

16. The fuel pump of claim 15, wherein at least one recess is formed in a radially outer surface of the stator core, and the recess forms another pathway in the motor, metal surfaces of the stator which directly contact said fuel are coated with the Zn-Al film.

17. The fuel pump of claim 13, wherein said Zn-Al film comprises a mixture of reaction resin, Zn and Al.

18. The fuel pump of claim 17, wherein said Zn and Al are in the form of flakes.

19. The fuel pump of claim 13, wherein said Zn-Al film has a thickness in a range of 5 μm to 30 μm.

20. The fuel pump of claim 13, wherein said Zn-Al film has a thickness in a range of 8 μm to 15 μm.
